(19) United States
(12) Patent Application Publication
(10) Pub. No.: US 2006/0288892 A1
(43) Pub. Date: Dec. 28, 2006

(54) Method and device for transporting sheets to a sheet processing machine

(75) Inventors: Peter Forch, Neustadt (DE); Markus Mohringer, Weinheim (DE); Burkhard Wolf, Dossenheim (DE); Darko Zimbakov, Wiesloch (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/476,293

(22) Filed: Jun. 28, 2006

(30) Foreign Application Priority Data
Jun. 28, 2005 (DE) 10 2005 029 931.8

(51) Int. Cl. B41F 13/24

(52) U.S. Cl. 101/232

(57) ABSTRACT

A method and a device for feeding sheets to a sheet-processing machine, especially a printing press, includes gripping a moving sheet at a sheet edge with grippers and determining a sheet location in a gripper bite. Upon deviation from a nominal or desired location, a correction of the sheet location in or opposite to a transport direction is performed transversely and obliquely thereto, and the sheet is transferred acceleratedly to a rotating advancing system.

### BACKGROUND OF THE INVENTION

### Field of the Invention

The invention relates to a method and a device for rapidly transporting sheets to a sheet-processing machine, especially a printing press, wherein the sheets are transversely and obliquely aligned on a transport path in and opposite to a sheet transporting direction.

The state of the art according to European Patent EP 10 44 908 B1, corresponding to U.S. Pat. No. 6,378,862 B1, discloses such a device, in particular for transporting plate-shaped objects to a punch. That device is formed basically of a reciprocatingly driven base carrier having a mechanical holding device, which is adjustable by actuators with respect to a base carrier in a transport plane. The adjustment occurs based upon position sensors, which grip the sheet edge and, upon deviation from a precalculated (desired) position, transmit control signals to the actuators, which control the holding device in such a manner that the sheets, respectively, in and opposite to the transport direction of the base carrier, can be aligned transversely and obliquely thereto. The holding device per se is formed of a format-wide clamping bar, which cooperates with a plate support.

The plates so-to-speak are fed from behind to the holding device and during the transfer to a conveyor device passed in stand-by position through the clamping gap.

That device is suitable, preferably, for low feeding or supplying speeds.

### SUMMARY OF THE INVENTION

It is accordingly an object of the invention to provide a method and a device for transporting or accelerating sheets to a sheet processing machine, which overcomes the hereinafore-mentioned disadvantages of the heretofore-known methods and devices of this general type and which are suitable especially for high feeding or high supplying speeds.

With the foregoing and other objects in view there is provided, in accordance with the invention, a method of transporting sheets and feeding sheets to a sheet processing machine. The method comprises gripping a sheet, moving in a transport direction, with a gripper device having a gripper bite and detecting a position of the sheet while in the gripper bite. Upon a deviation of an actual position from a desired position of the sheet, during a transport movement of the sheet to a moving advancing device, the sheet is aligned in or counter to the transport direction obliquely and transversely to the transport direction. This occurs by aligning the sheet in or counter to the transport direction by a simultaneous acceleration or deceleration of a driven carrier in parallel movement paths, carrying out oblique alignment with a different drive of the carrier in the movement paths, and carrying out lateral alignment with a lateral shifting of the gripper device.

With the objects of the invention in view, there is also provided a device for carrying out the method of transporting sheets and feeding sheets to a sheet processing machine. The device comprises a device disposed on the transport path for detecting a position of the sheet and for aligning the sheet. A gripper device is guided in the movement paths. The gripper device is drivable on each movement path independently of the other movement path, and the gripper device is mounted for lateral displaceable relative to the movement paths.

It is a particular advantage of the method that the sheets, after a separation from a sheet pile, or produced by a cross-cutter, can be fed continuously, without stopping, to an operating station, preferably a printing unit of a printing machine. Due to these measures, the feeding or supplying speed can be increased and thus be adapted to currently possible printing speeds.

A particular advantage of the invention is the simultaneous or independent control of a carrier for the gripper device, which is guided in parallel rails. Due to this measure, a sheet held in the gripper direction, with simultaneous control of a linear motor which is provided, can be accelerated in sheet transport direction in order, for example, to accelerate the sheet to the speed of the conveyor system and, in addition thereto, correct late sheets.

Furthermore, due to the reduction in the normal acceleration, early sheets can be corrected. An independent control results in an offset or crossing movement of the carrier and serves for correction of misaligned or out-of-square sheets. A possibility for laterally adjusting the gripper device with respect to the carrier serves for the lateral alignment, preferably with the aid of a parallelogram-type adjusting device.

A simple structure is represented, for example having a mechanical control roller-cam device. The respective gripper opening and closing movements preferably occur by a mechanical control. Alternatively, however, a suction gripper device is also advantageous. Further inventive developments or refinements, such as a squared-off or angular adjustment of the feeding device with respect to the conveyor device for the purpose of adjusting the sheet thickness, are described below.

Other features which are considered as characteristic for the invention are set forth in the appended claims.

Although the invention is illustrated and described herein as embodied in a method and a device for transporting sheets to a sheet processing machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, longitudinal-sectional view of a sheet-fed rotary printing machine;

FIG. 2 is a fragmentary, enlarged, top-plan view of a sheet feeding device according to the invention;

FIG. 3 is a fragmentary, side-elevational view of the sheet feeding device;

FIG. 4 is a perspective view of the sheet feeding device;

FIG. 5 is a fragmentary, side-elevational view of a gripper control; and

FIG. 6 is a fragmentary, side-elevational view of a pivotable, squared-off or angularly adjustable sheet feeding device.

### DESCRIPTION OF THE PREFERRED EMBODIMENTS

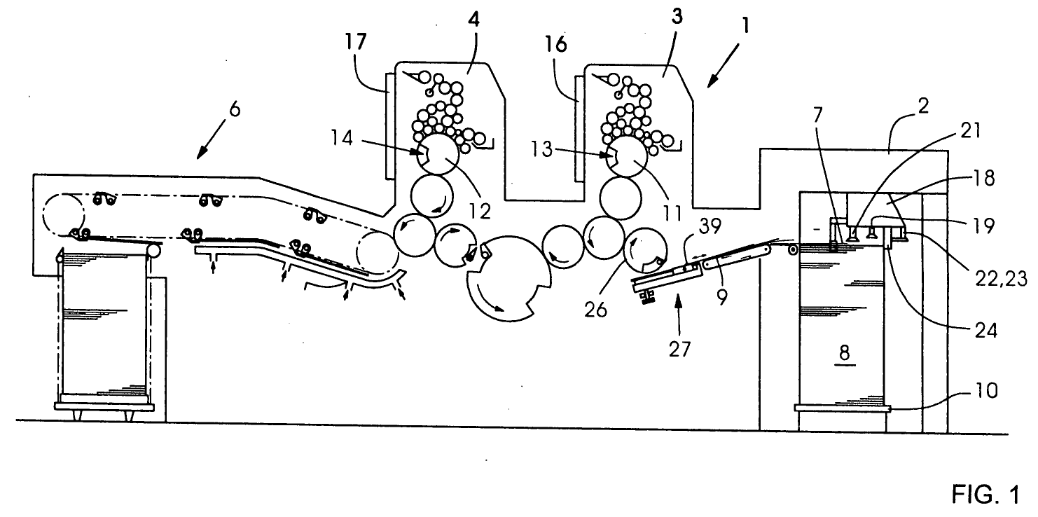

Referring now to the figures of the drawings in detail and first, particularly, to FIG. 1 thereof, there is seen a sheet processing machine, for example a printing press 1, for sheets 7. The printing press 1 has a feeder 2, at least one respective printing unit 3, 4 and a delivery 6. The sheets 7 are removed from a sheet pile 8 and are fed singly or in a shingle-shaped or streaming manner over a feed table 9 of a sheet-feeding device or sheet transport and acceleration system 27, which acceleratedly transfers the sheets 7 to the printing units 3, 4. The printing units 3, 4, as is known, each include a respective plate cylinder 11, 12. The plate cylinders 11, 12 each have a respective device 13, 14 for fastening flexible printing plates thereon. In addition thereto, a respective device 16, 17 for semiautomatic or fully automatic printing-plate exchange is associated with each plate cylinder 11, 12.

The sheet pile 8 lies on a controllingly liftable pile board 10. Removal of the sheets 7 is effected from the upper side of the sheet pile 8 by a so-called suction head 18 which, among other things, has a number of lifting and pulling suckers 19, 21 for the singling of the sheets 7.

Furthermore, blast devices 22 for loosening up the upper sheet layers, and sensing elements 23 for pile follow-up, are provided. A number of side and rear stops 24 are provided for alignment or registration of the sheet pile 8, especially the upper sheets 7 of the sheet pile 8.

In order to transfer the sheet 7 from a shingle stream or a stream of consecutively transported sheets 7 (single sheet transport) to a cylinder 26 of the printing press, for example a feed cylinder 26, the sheet feeding or transport and accelerating system 27 is disposed between the feed table 9 and the feed cylinder 26. The feed cylinder 26 may also be referred to as an advancing device.

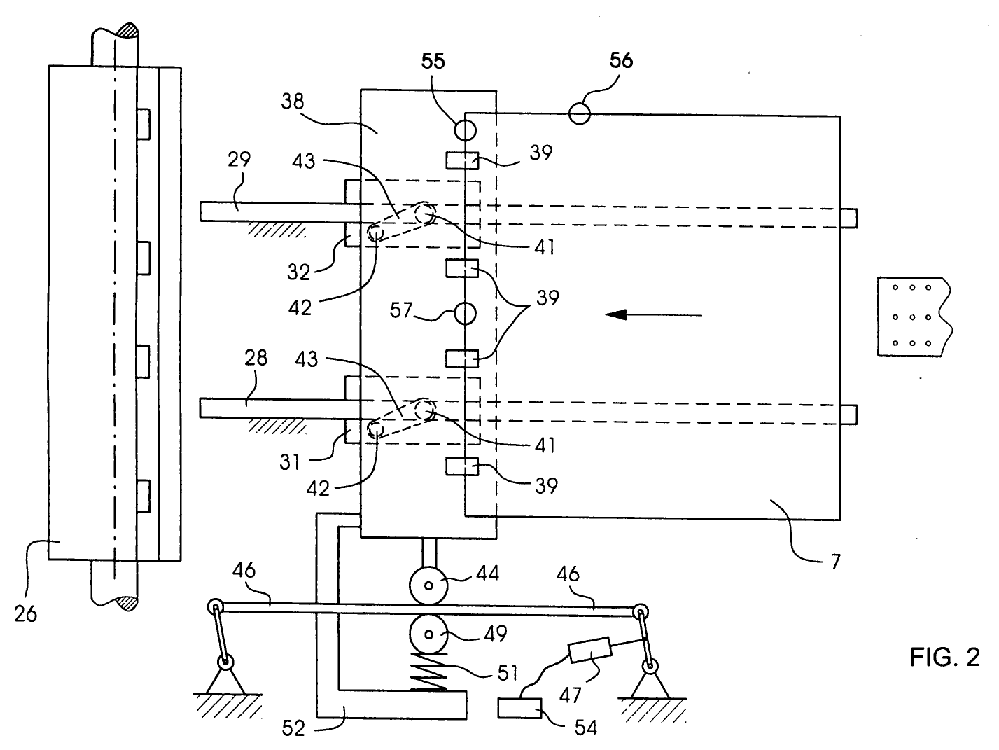

As is seen in FIG. 2, the respective sheet transport and accelerating system 27 is formed substantially of two parallel rails or movement paths 28, 29 disposed in sheet transport direction, each having a respective slide 31, 32 guided thereon, with which they form a respective drive, preferably an electromagnetic linear drive. The drives 28, 31 and 29, 32 are controllable simultaneously and independently of one another.

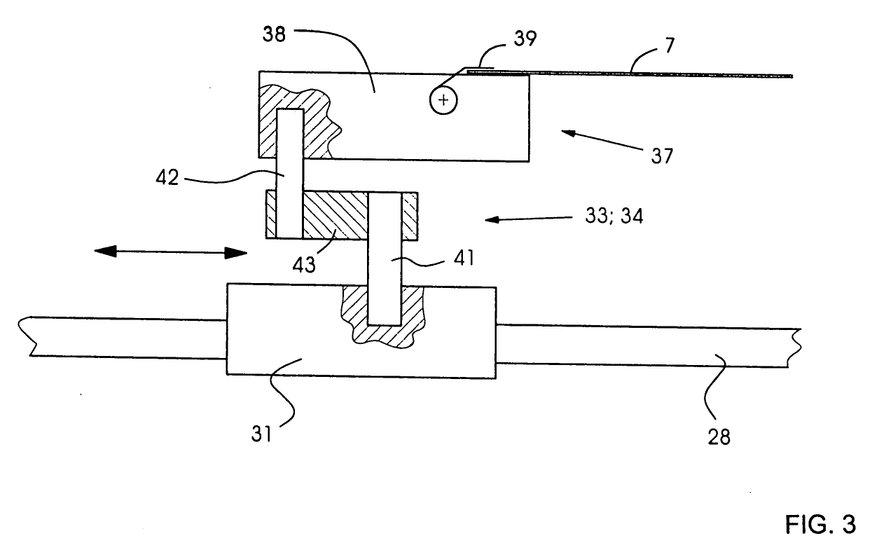

As is seen in FIGS. 2 and 3, the two slides 31,32 are connected through a respective articulated connection 33, 34 with a gripper device 37, preferably with a gripper bridge or driven carrier 38, which carries mechanically actuatable grippers 39. The gripper bridge 38 is disposed in the vicinity of the slides 31, 32 in each case, so as to be laterally displaceable in a parallogram-like manner. For this purpose, the respective articulated connections 33, 34 are formed as respective eccentric couplers, with a first pin 41 being disposed at the slide 31 and a second pin 42 being disposed on the gripper bridge 37. The two pins 41 and 42 are connected by a coupler 43.

A rotatably mounted control roller 44, which is provided on the gripper bridge 38, cooperates with an adjustably disposed control cam, preferably in the form of a guide rail 46. The guide rail 46 is stationarily disposed parallel to the sheet transport direction and, with the aid of an actuator 47, for example a linear motor or an actuating drive, is adjustably mounted transversely to the sheet transport direction. A spring-loaded counter-roller 49 which is provided opposite to the control roller 44, has an accumulator 51 being braced against an abutment 52 that is fastened to the gripper bridge 38. The guide rail 46 is always located between the control roller 44 and the counter-roller 49.

The actuator 47 is connected to a control computer 54 of the sheet-processing machine and, when the lateral position of the sheet deviates, performs correction movements, which result in the guide rail 46 being shifted transversely to the sheet transport direction. This shift, due to the contact of the control roller 44 with the guides 46, causes the gripper bridge 38 and therewith also the sheet 7 held in the grippers 39, to perform a lateral correction movement. The guide rail 46 extends over the entire transport path from the feeder table 9 to the conveyor device or feeding cylinder 26. Through the use of this measure, a large time window is made available for the alignment or adjustment of the sheets.

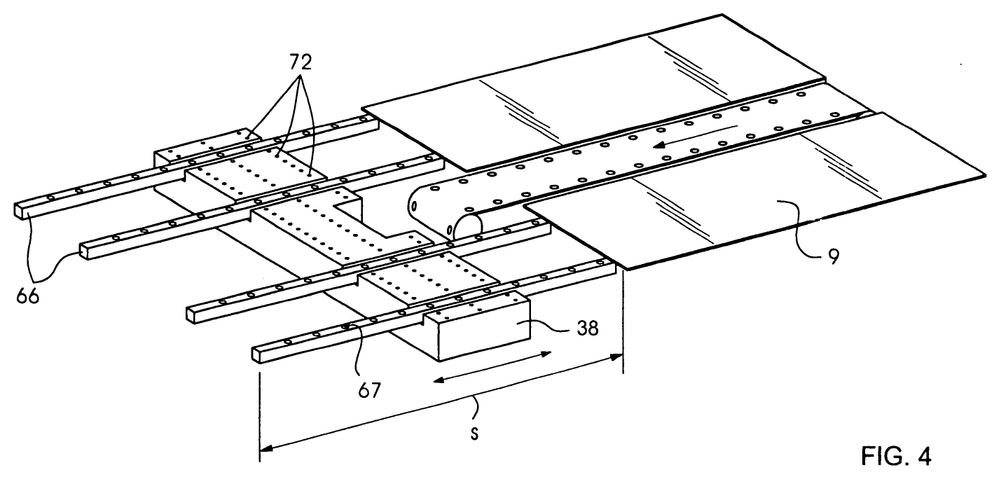

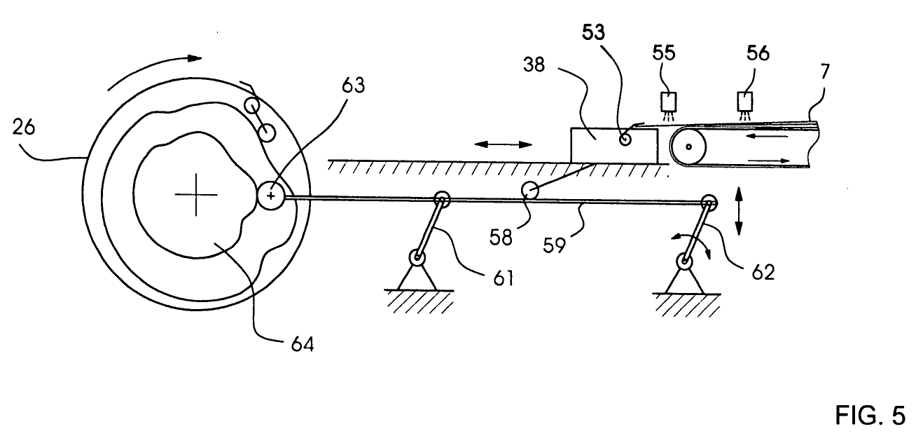

FIG. 5 shows that for controlling gripper opening and closing movement, a gripper shaft 53 carrying the gripper 39 is swivellably mounted on the gripper bridge 38. A control roller 58, which is disposed at one end of the gripper shaft, cooperates with a synchronously switchable guide rail 59. The guide rail 59 is associated with two couplers or connecting rods 61, 62, which are pivotably mounted on a side frame, so as to deflect outwardly in parallel. A control roller 63, at an end of the guide rail 59, cooperates with a control cam 64 which is driven, for example, by the feed cylinder 26. The guide rail 59 is extended at least over an entire transport and alignment path s (indicated in FIG. 4) of the gripper bridge 38.

As is seen in FIGS. 2 and 5, sensors 55, 56 and 57, which are adjustable in accordance with the format for determining the sheet position in the gripper bite or closure of the gripper 39, are disposed at the leading edge and side edge of the sheet, above the transport and alignment paths, lengths or stretches. The sensors 55 to 57 are connected to the control computer 54, which performs a reference value/actual value comparison and, in the case of possible deviations, transmits, especially to the actuator 47, a respective adjusting and correction command for control devices for lateral or side sheet position. When an early or late sheet is recognized, the linear drives having the rails 28 and 31 are controlled in parallel, so that a corresponding acceleration or delay is respectively superimposed on the normal transport speed and acceleration.

When a misaligned sheet is recognized, a suitable independent control of the drives having the rails 28, 31 occurs.

The correction movements of the gripper bridge 38 and, therewith, of the sheet 7, are concluded up to the transfer to the rotating feed cylinder 26, so that the sheet 7 can be surrendered in alignment, without it being stopped on the transport path to the first operating station, for example the printing unit 3.

As is seen in FIG. 4, sheet supporting elements 66 which are spaced apart from one another extend between the end of the feed table 9 and the feed cylinder 26 over the entire transport and alignment path, stretch or length. These elements support the sheet 7 which is gripped only at the leading edge thereof, on the transport path. The support elements 66, which are formed as rods, may have blast air openings 67, especially for throttled blast air, at their surface which is in contact with the sheet.

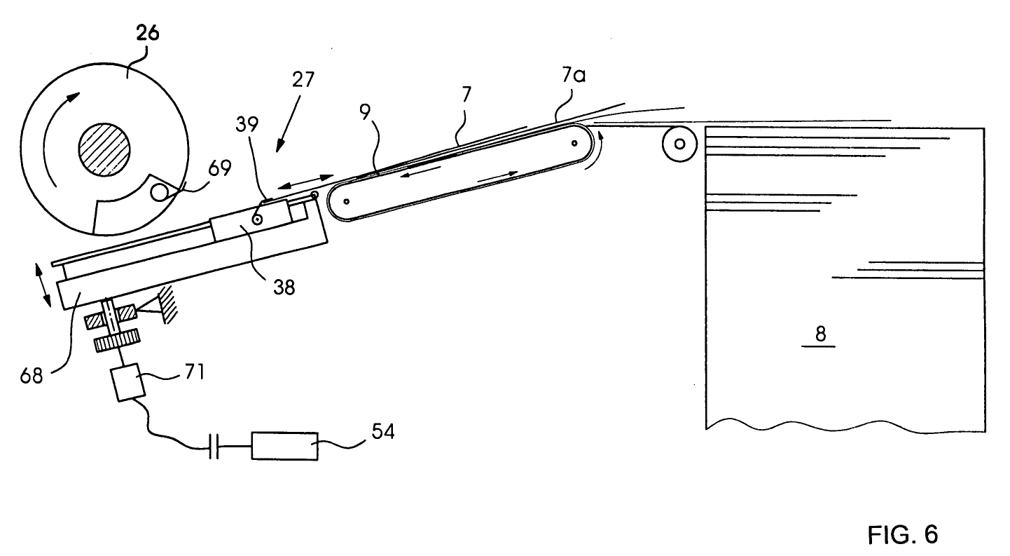

The entire transport and alignment path, length or stretch is disposed in a frame or stand 68 shown in FIG. 6, which is disposed opposite the feeding table 9, placed in order, so as to be angularly adjustable, in order to ensure that an exact change in spacing of the gripper 39 from grippers 69 of the feed cylinder 26 can take place manually or by a drive motor 71 controllable by the control computer 54, for example during the processing of different sheet thicknesses.

In order to transport the sheets in register from the feeder pile or a non-illustrated cross-cutter into the processing station of the sheet processing machine, especially a printing press, they are fed by the feed table 9 individually in succession or preferably shingle-like to the grippers 39 of the gripper bridge 38, which grips the respectively leading or front sheet 7 out of the moving overlapping or shingle stream. In the gripper bite or closure, the sheet position is determined by the sensors 55 to 57 that are respectively disposed preferably over and above the conveyor path, stretch or length, and suitable correction movements are introduced, if necessary or desirable, on the path to the feed cylinder 26, so that the sheet can be transferred in register to the rotating feed cylinder 26, without mechanical aligning aids and without stopping.

As an alternative to a mechanical gripper bite or closure of the sheet by grippers disposed on a gripper bridge, it is naturally also possible to subject the gripper bridge 38 to suction air or to provide suction grippers 72 shown in FIG. 4.

This application claims the priority, under 35 U.S.C. §119, of German application DE 10 2005 029 931.8, filed Jun. 28, 2005; the prior application is herewith incorporated by reference in its entirety.

We claim:

1. A method of transporting sheets and feeding sheets to a sheet processing machine, the method comprising the following steps:
gripping a sheet, moving in a transport direction, with a gripper device having a gripper bite;
detecting a position of the sheet while in the gripper bite;
upon a deviation of an actual position from a desired position of the sheet, during a transport movement of the sheet to a moving advancing device, aligning the sheet in or counter to the transport direction obliquely and transversely to the transport direction by:
aligning the sheet in or counter to the transport direction by a simultaneous acceleration or deceleration of a driven carrier in parallel movement paths;
carrying out oblique alignment with a different drive of the carrier in the movement paths; and
carrying out lateral alignment with a lateral shifting of the gripper device.

2. A device for transporting sheets and feeding sheets to a sheet processing machine, the device comprising:
a device disposed on the transport path for detecting a position of the sheet and for aligning the sheet according to claim 1;
said device including a gripper device guided in said movement paths, said gripper device being drivable on each movement path independently of the other movement path, and said gripper device being mounted for lateral displaceable relative to said movement paths.

3. The device according to claim 2, wherein said movement paths are rails.

4. The device according to claim 3, which further comprises linear drives for driving said gripper device along said rails.

5. The device according to claim 3, wherein said gripper device has a gripper bridge displaceable in a parallelogram-like manner relative to said rails.

6. The device according to claim 2, wherein said device for detecting the position of the sheet is disposed above the transport path and above the sheet.

7. The device according to claim 2, which further comprises a feed cylinder, a manual or motorized adjustable frame for swiveling relative to said feed cylinder, and a sheet transport and acceleration system mounted in said adjustable frame and carrying said gripper device.

8. The device according to claim 2, which further comprises a feed table, a feed cylinder, and sheet guiding elements disposed in an alignment and transport region between said feed table and said feed cylinder.

9. The device according to claim 8, wherein said sheet guiding elements have blast air openings at a side of said sheet guiding elements facing towards the sheet.

10. The device according to claim 9, wherein said blast air openings emit throttled blast air.

11. The device according to claim 2, wherein the sheet processing machine is a rotary printing press.
